(19) United States
(12) Patent Application Publication
(10) Pub. No.: US 2024/0025425 A1
(43) Pub. Date: Jan. 25, 2024

(54) CALIBRATION DEVICE FOR CALIBRATING A DRIVER ASSISTANCE SYSTEM

(71) Applicant: Robert Bosch GmbH, Stuttgart (DE)

(72) Inventors: Mauro Disaro, Stuttgart (DE); Alfons Doerr, Stuttgart (DE); Buelent Barcin, Kirchheim/Jesingen (DE); Dirk Schoenfeld, Altbach (DE); Georg Wagner, Filderstadt (DE); Hans Mai, Goeppingen (DE); Reinhard Hoss, Plochingen (DE)

(21) Appl. No.: 18/308,608

(22) Filed: Apr. 27, 2023

(30) Foreign Application Priority Data
Apr. 29, 2022 (DE) 10 2022 204 243.3

(51) Int. Cl. B60W 50/04; G06T 7/60; G06T 7/70

(52) U.S. Cl. CPC B60W 50/045; G06T 7/60; G06T 7/70; B60W 2050/0083

(57) ABSTRACT

A calibration device for calibrating a driver assistance system. The calibration device includes a calibration board and two optically active elements, which make it possible to determine the position and/or the alignment of a motor vehicle with respect to the calibration device. The two optically active elements are attached at two mutually opposing ends of a holding device. The holding device has a longitudinal axis, which essentially extends in the horizontal direction. An acceleration sensor is attached at each of the two mutually opposing ends of the holding device.

### FIELD

The present invention relates to a calibration device for calibrating driver assistance systems in motor vehicles.

### BACKGROUND INFORMATION

For calibrating driver assistance systems installed in motor vehicles, calibration devices are used, in particular, in the repair shop field, which include a measuring board including at least one predefined optical pattern, which is detected by an image recording device of a driver assistance system to be calibrated, in order to calibrate the driver assistance system.

For calibrating the driver assistance system, the position and/or the alignment of the vehicle with respect to the calibration device must be known with high accuracy. Calibration devices therefore frequently include optically active elements, e.g., cameras, which are designed to optically detect a motor vehicle situated in front of the calibration device in order to be able to determine the position and/or the alignment of the motor vehicle with respect to the calibration device.

In such calibration devices, deviations of the alignment of the optically active elements from a predefined alignment result in errors during the determination of the position and/or the alignment of the motor vehicle, which may impair the quality of the calibration of the driver assistance system.

### SUMMARY

It is an object of the present invention to provide an improved calibration device for calibrating driver assistance systems installed in motor vehicles in order to enhance the quality of the calibration.

A calibration device according to an example embodiment of the present invention for calibrating a driver assistance system includes a calibration board including at least one optical pattern, which is optically detectable by an image recording device of the driver assistance system, to calibrate the driver assistance system. The calibration device furthermore includes two optically active elements, for example cameras, which make it possible to determine the position and/or the alignment of a motor vehicle, situated in front of the calibration device, with respect to the calibration device.

The calibration also has a holding device. The holding device has a longitudinal axis, which essentially extends in the horizontal direction in parallel to the plane of the calibration board. The two optically active elements are attached at a predefined distance with respect to one another, in particular at two mutually opposing end areas of the holding device.

In each case one acceleration sensor is attached at the two mutually opposing ends of the holding device, which makes it possible to determine an orientation, in particular an inclination, of the respective end of the holding device with respect to gravity.

The present invention also includes a method for determining the position and/or the orientation of a motor vehicle positioned in front of a calibration device, which is provided for calibrating driver assistance systems. According to an example embodiment of the present invention, in the process, the method includes positioning the motor vehicle in front of the calibration device; recording images of the motor vehicle using the at least two optically active elements which are attached to the holding device of the calibration device; determining the inclination and/or the torsion of the holding device about its longitudinal axis from measured values supplied by the two acceleration sensors; and evaluating the images of the motor vehicle recorded by the two optically active elements to determine the position and/or the orientation of the motor vehicle in front of the calibration device, taking the torsion of the holding device determined with the aid of the acceleration sensors into consideration.

The present invention also includes a method for calibrating a driver assistance system using a calibration device according to the present invention. According to an example embodiment fo the present invention, the method including determining the position and/or the alignment of the motor vehicle in front of the calibration device using a method according to the present invention, as described above. The method moreover includes recording at least one image of the calibration board using an image recording device of the driver assistance system, and evaluating the at least one recorded image of the calibration board, taking the previously determined position and/or alignment of the motor vehicle in front of the calibration device into consideration, to calibrate the driver assistance system.

By determining the orientations of the two ends of the holding device, and thus also of the optically active elements attached at the two ends of the holding device with respect to gravity, it is possible to reliably recognize and correct errors which may result during the determination of the position and of the orientation of a motor vehicle situated in front of the calibration device from a different orientation of the two optically active elements. A different orientation of the two optically active elements may, in particular, be the consequence of a torsion of the holding device about its longitudinal axis.

The position and the orientation of the motor vehicle in front of the calibration device may be determined with high accuracy in this way.

Since errors during the calibration of the driver assistance system, which may result from an erroneous determination of the position and/or of the orientation of the motor vehicle situated in front of the calibration device, may thus be significantly reduced, the quality of the calibration of the driver assistance system may be considerably enhanced.

Since, according to the present invention, a torsion of the holding device may be detected and corrected with the aid of acceleration sensors, the requirements with regard to the torsional stiffness of the holding device may be reduced, without impairing the quality of the calibration. The holding device may thus be manufactured more cost-effectively, in particular, from a more cost-effective, less torsionally stiff material.

In one specific embodiment of the present invention, the two optically active elements are cameras, in particular, 2D cameras or 3D cameras, which are designed to record images of a motor vehicle positioned in front of the calibration device. From the images which were recorded by such optically active elements or cameras, the position and the alignment of the motor vehicle in front of the calibration device may be determined well and with high accuracy using conventional methods of image evaluation.

In one specific embodiment of the present invention, the calibration device includes an evaluation device, which is designed to evaluate the measured values supplied by the acceleration sensors in order to determine a torsion and/or an inclination of the holding device about its longitudinal axis.

Moreover, the evaluation device may be designed to evaluate the images recorded by the optically active elements or cameras, taking the previously determined torsion and/or inclination of the holding device into consideration, in order to determine the position and the alignment of the motor vehicle in front of the calibration device.

In one specific embodiment of the present invention, the evaluation device is designed to correct data which relate to the position and/or the orientation of the motor vehicle in front of the calibration device and which were determined from the images recorded by the optically active elements or cameras, based on the measured values supplied by the acceleration sensors.

The evaluation device may, in particular, be designed to determine a torsion of the holding device about its longitudinal axis, and to correct errors which result during the evaluation of the images supplied by the optically active elements from a torsion of the holding device.

Errors during the determination of the position and alignment of the motor vehicle in front of the calibration device which result from the torsion of the holding device may negatively influence the quality of the calibration of the driver assistance system. The quality of the calibration may thus be considerably enhanced by the correction of these errors.

In one specific embodiment of the present invention, the evaluation device is designed to determine an inclination of the holding device about its longitudinal axis from the arithmetic mean of the measured values supplied by the two acceleration sensors.

In one specific embodiment of the present invention, acceleration sensors and the evaluation device are designed to transfer the measured values supplied by the acceleration sensors from the acceleration sensors to the evaluation device in a wired manner. A wired data transfer is particularly cost-effective and reliable.

In one specific embodiment of the present invention, acceleration sensors and the evaluation device are designed to transfer the measured values supplied by the acceleration sensors wirelessly from the acceleration sensors to the evaluation device. A wireless data transfer simplifies the installation, handling, and maintenance of the calibration device since cable connections may be dispensed with.

The wireless data transfer may take place via WLAN, via Bluetooth®, or using a similar technology.

The acceleration sensors and possibly present senders for the wireless data transfer may be supplied with electrical energy via cable connections, or by batteries, rechargeable batteries, or solar cells.

The images recorded by the optically active elements may also be transferred in a wired manner or wirelessly to the evaluation device.

### BRIEF DESCRIPTION OF THE DRAWINGS

FIG. 1 shows, in a schematic representation, a top view onto a measuring station including a motor vehicle and a calibration device designed according to an example embodiment of the present invention.

FIG. 2 shows a perspective front view of a calibration device designed according to an example embodiment of the present invention.

FIG. 3 shows an outer area of a holding device of the calibration device in an enlarged representation, according to an example embodiment of the present invention.

FIG. 4 schematically illustrates the determination of the orientation, in particular, of the rotation, of the two ends of the holding device, according to an example embodiment of the present invention.

### DETAILED DESCRIPTION OF EXAMPLE EMBODIMENTS

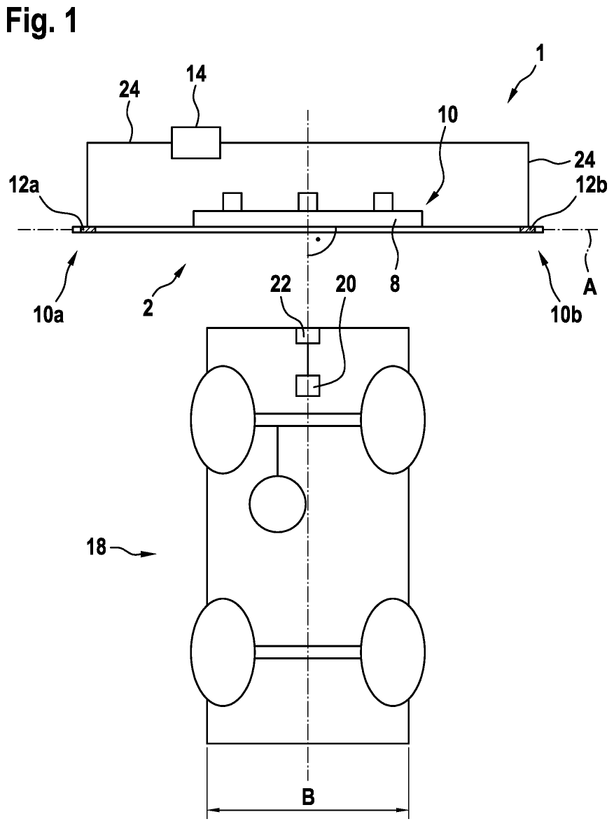

FIG. 1, in a schematic top view, shows a measuring station 1 including a motor vehicle 18, which is equipped with a driver assistance system 20 and an image recording device 22.

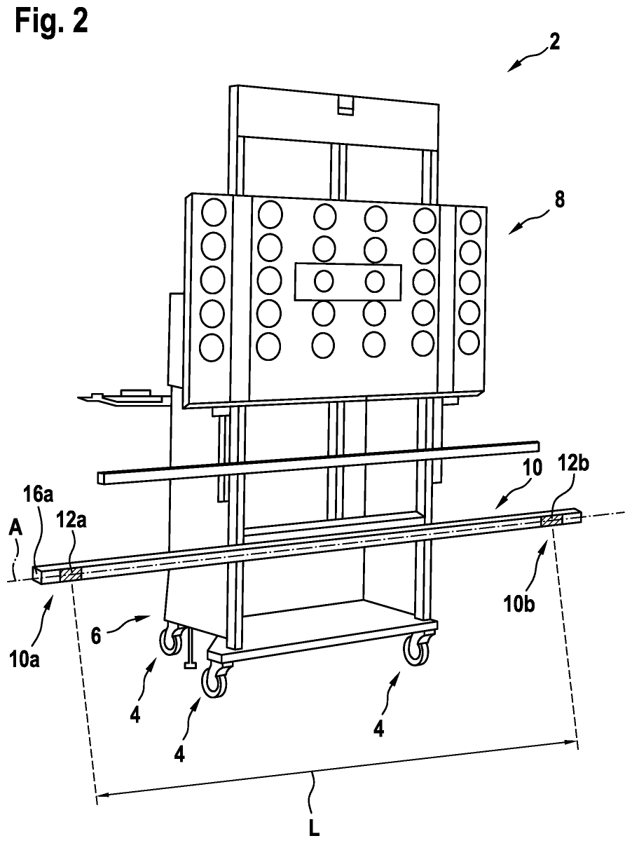

A calibration device 2 according to the present invention is positioned in front of motor vehicle 18. Calibration device 2 includes a calibration board 8 including an optical pattern (see FIG. 2), which is optically detectable by image recording device 22 to calibrate driver assistance system 20.

FIG. 2 shows a perspective front view of a calibration device 2 designed according to the present invention for calibrating a driver assistance system 20 (see FIG. 1), which is installed in a motor vehicle 18.

Calibration device 2 includes a rack 6 which is supported on casters 4 and to which a calibration board 8 is attached. Brakes, which are not shown in FIG. 2, may be provided at casters 4. The brakes may be activated to prevent calibration device 2 from inadvertently rolling away after calibration device 2 has been positioned in front of motor vehicle 18.

An optical pattern is formed on calibration board 8, which is intended to be optically detected by image recording device 22 of driver assistance system 20 in order to make it possible to calibrate driver assistance system 20.

The specific configuration of the optical pattern shown in FIG. 2 is only provided by way of example. Depending on the requirements of driver assistance system 20 to be calibrated, it is also possible for other patterns to be formed on calibration board 8.

Beneath calibration board 8, a holding device 10 is attached to rack 6. In other exemplary embodiments, which are not explicitly shown in the figures, holding device 10 may also be situated above calibration board 8 or behind calibration board 8.

Holding device 10 may be made of metal or of plastic. Holding device 10 may, in particular, encompass a profile which is made of metal or plastic.

Holding device 10 extends from left to right in a rod-shaped manner along a longitudinal axis A in the horizontal direction in parallel to the plane of calibration board 8. Holding device as is shown in FIGS. 1 and 2, extends, in particular, beyond the lateral edges of calibration board 8. An optically active element 12a, 12b is provided in each case in or at outer end areas 10a, 10b of holding device 10. Optically active elements 12a, 12b are designed to record images of a motor vehicle 18 which is situated in front of calibration device 2. Optically active elements 12a, 12b may, for example, be designed as mono cameras or as stereo cameras.

Optically active elements 12a, 12b may be designed for recording light in the visible range and/or for recording light in the infrared range. Optically active elements 12a, 12b may be designed as black and white cameras or as color cameras.

Distance L between the two optically active elements 12a, 12b in the horizontal direction is greater than maximum width B of vehicles 18 whose driver assistance systems 20 may be calibrated with the aid of calibration device 2.

Distance L between the two optically active elements 12a, 12b is typically in the range of 180 cm to 300 cm.

The images recorded by optically active elements 12a, 12b are transferred wirelessly or in a wired manner to an evaluation device 14 (see FIG. 1), which is designed to evaluate the images transferred by optically active elements 12a, 12b in order to determine the position and/or the alignment of motor vehicle 18 with respect to calibration device 2.

According to the present invention, a respective acceleration sensor 16a, 16b is additionally provided in or at outer end areas 10a, 10b of holding device 10.

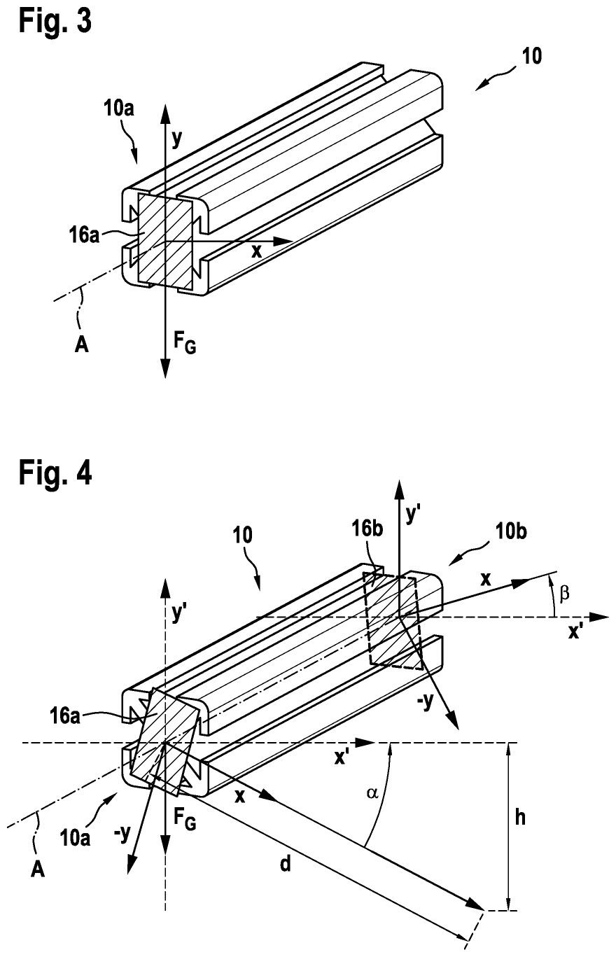

FIG. 3 shows an outer area of a holding device 10 designed according to the present invention in an enlarged perspective representation.

Optically active elements 12a, 12b attached to holding device 10 are not shown in FIG. 3.

In the exemplary embodiment in FIG. 3, an acceleration sensor 16a is attached to an outer front face at a first outer end area 10a of the rod-shaped holding device 10. A second acceleration sensor 16b, which is not shown in FIG. 3, is attached on the opposite front face at a second outer end area 10b of holding device 10.

The two acceleration sensors 16a, 16b are designed to detect acceleration forces along axes x, y of acceleration sensors 16a, 16b. The acceleration forces detected by acceleration sensors 16a, 16b may, in particular, be acceleration forces caused by gravity (gravitational forces F_{G}).

By evaluating the signals supplied by acceleration sensors 16a, 16b, it is possible to determine the direction of acceleration or gravitational force F_{G} with respect to axes x, y of acceleration sensors 16a, 16b. Since it is known that gravitational force F_{G} is vertically aligned, it is possible to determine the spatial orientations of the two acceleration sensors 16a, 16b with respect to gravitational force F_{G}, and thus angles of rotation α, β of the two acceleration sensors 16a, 16b about longitudinal axis A of holding device 10, from the signal supplied by acceleration sensors 16a, 16b. This is schematically illustrated in FIG. 4.

Using a first acceleration sensor 16a, which is attached at first end area 10a of holding device 10, a first torsion angle α is determined, which indicates the rotation or inclination of first end area 10a of holding device 10 about its longitudinal axis A.

Using a second acceleration sensor 16b, which is attached at a second end area 10b of holding device 10, a second torsion angle β is determined, which indicates the rotation or inclination of second end area 10b of holding device 10 about its longitudinal axis A.

Arithmetic mean γ=½ (α+β) of the two torsion angles α, β indicates the inclination (“pitch”) of holding device 10 about its longitudinal axis A.

Difference Δ=α-β between the two torsion angles α, β indicates the torsion of holding device 10 about its longitudinal axis A.

A torsion of holding device 10 which is not taken into consideration and corrected during the evaluation of the images recorded by two optically active elements 12a, 12b has a negative impact on the results of the determination of the position and the alignment of motor vehicle 18 in front of calibration device 2, and thus also on the quality of a subsequent calibration of driver assistance system 20.

The data supplied by the two acceleration sensors 16a, 16b, which allow the two torsion angles α, β to be determined, are thus transferred to evaluation device 14, and taken into consideration by evaluation device 14 during the evaluation of the images supplied by optically active elements 12a, 12b to correct errors which result during the evaluation of the images from inclination γ and, in particular, torsion Δ of holding device 10.

In this way, distances d and heights h, which are determined by the evaluation of the images supplied by optically active elements 12a, 12b, may be corrected.

As a result, the position and the alignment of motor vehicle 18 with respect to calibration device 2 may be determined with high accuracy. In this way, the quality of the calibration of driver assistance system 20 carried out using calibration device 2 may be considerably enhanced.

Since the determination according to the present invention of inclination γ and torsion Δ of holding device 10 is based on gravitational force F_{G} always acting in the vertical direction, inclination γ and torsion Δ of holding device 10 may only be completely detected and compensated when longitudinal axis A of holding device 10 extends in the horizontal direction, i.e., orthogonal to gravitational force F_{G}. In particular, a torsion Δ about a vertical axis cannot be determined using acceleration sensors 16a, 16b attached at the front faces of holding device 10.

If longitudinal axis A of holding device 10 extends obliquely, i.e., neither completely in the horizontal direction, nor completely in the vertical direction, a torsion Δ of holding device 10 about its longitudinal axis L may only be partially determined with the aid of acceleration sensors 16a, 16b. It is therefore advantageous to level holding device 10 prior to the calibration, e.g., with the aid of a spirit level, so that it is aligned as exactly as possible in the horizontal direction.

The data supplied by optically active elements 12a, 12b and acceleration sensors 16a, 16b may be transferred via cable connections 24 or wirelessly to evaluation device 14. A wireless data transfer may take place via a WLAN connection, via a Bluetooth® connection, or using a similar technology for wireless data transfer.

Cable connections 24 which are used for the data transfer in a wired manner may also be used to supply optically active elements 12a, 12b and acceleration sensors 16a, 16b with electrical energy.

In the case of a wireless data transfer, optically active elements 12a, 12b and acceleration sensors 16a, 16b may be supplied with electrical energy by electric batteries, electric rechargeable batteries, or solar cells to avoid a cable connection 24 for energy supply.

1-10. (canceled)

11. A calibration device for calibrating a driver assistance system, the calibration device comprising:
a calibration board;
two optically active elements; and
a holding device, the holding device having a longitudinal axis which extends in a horizontal direction;
wherein the two optically active elements are attached at two mutually opposing end areas of the holding device, and a respective acceleration sensor is attached at each of the two mutually opposing end areas of the holding device.

12. The calibration device as recited in claim 11, wherein the two optically active elements are cameras which are configured to record images of a motor vehicle placed in front of the calibration device.

13. The calibration device as recited in claim 12, wherein the two optically active elements are 2D cameras or 3D cameras.

14. The calibration device as recited in claim 11, further comprising:
an evaluation device configured to evaluate measured values supplied by the respective acceleration sensors to determine a torsion and/or an inclination of the holding device about its longitudinal axis.

15. The calibration device as recited in claim 14, wherein the respective acceleration sensors and the evaluation device are configured to transfer the measured values supplied by the respective acceleration sensors in a wired manner or wirelessly from the respective acceleration sensors to the evaluation device.

16. The calibration device as recited in claim 14, wherein the evaluation device is configured to correct geometric data which were determined from images recorded by the two optically active elements, based on the measured values supplied by the respective acceleration sensors.

17. The calibration device as recited in claim 14, wherein the evaluation device is configured to determine an inclination of the holding device about its longitudinal axis from an arithmetic mean of the measured values supplied by the respective acceleration sensors.

18. The calibration device as recited in claim 14, wherein the evaluation device is configured to determine a torsion of the holding device about its longitudinal axis from a difference of the measured values supplied by the respective acceleration sensors.

19. A method for determining a position and/or a alignment of a motor vehicle in front of a calibration device for calibrating a driver assistance system, the calibration device including a calibration board, two optically active elements, and a holding device, the holding device having a longitudinal axis which extends in a horizontal direction, wherein the two optically active elements are attached at two mutually opposing end areas of the holding device, and a respective acceleration sensor is attached at each of the two mutually opposing end areas of the holding device, the method comprising:
positioning the motor vehicle in front of the calibration device;
recording images of the motor vehicle using the two optically active elements;
determining an inclination and/or a torsion of the holding device about its longitudinal axis from measured values supplied by the respective acceleration sensors; and
evaluating the images of the motor vehicle recorded by the two optically active elements to determine the position and/or the alignment of the motor vehicle in front of the calibration device, taking the inclination and/or torsion of the holding device determined using the respective acceleration sensors into consideration.

20. The method as recited in claim 19, further comprising:
transferring the measured values supplied by the respective acceleration sensors in a wired manner or wirelessly from the acceleration sensors to the evaluation device.

21. A method for calibrating a driver assistance system in a motor vehicle, using a calibration device including a calibration board, two optically active elements, and a holding device, the holding device having a longitudinal axis which extends in a horizontal direction, wherein the two optically active elements are attached at two mutually opposing end areas of the holding device, and a respective acceleration sensor is attached at each of the two mutually opposing end areas of the holding device, the method comprising:
determining a position and/or an alignment of the motor vehicle in front of the calibration device, including:
positioning the motor vehicle in front of the calibration device;
recording images of the motor vehicle using the two optically active elements,
determining an inclination and/or a torsion of the holding device about its longitudinal axis from measured values supplied by the respective acceleration sensors, and
evaluating the images of the motor vehicle recorded by the two optically active elements to determine the position and/or the alignment of the motor vehicle in front of the calibration device, taking the inclination and/or torsion of the holding device determined using the respective acceleration sensors into consideration;
recording at least one image of the calibration board using an image recording device of the driver assistance system; and
evaluating the at least one recorded image of the calibration board, taking the position and/or the alignment of the motor vehicle in front of the calibration device into consideration, to calibrate the driver assistance system.
